(19) United States
(12) Patent Application Publication
(10) Pub. No.: US 2025/0242387 A1
(43) Pub. Date: Jul. 31, 2025

(54) HANDHELD BODY AND OBJECT WASHING APPARATUS

(71) Applicant: Scott Snare, Hurricane, UT (US)

(72) Inventor: Scott Snare, Hurricane, UT (US)

(21) Appl. No.: 19/037,448

(22) Filed: Jan. 27, 2025

Related U.S. Application Data
(60) Provisional application No. 63/625,673, filed on Jan. 26, 2024.

(51) Int. Cl. B08B 1/30; A47K 7/02; B08B 1/10; B08B 1/54

(52) U.S. Cl. CPC B08B 1/30; A47K 7/022; A47K 7/028; B08B 1/10; B08B 1/54

(57) ABSTRACT

A handheld washing apparatus features a first member, a second member, and a washing material configured to pass through the first member and couple to the second member, the first member being slidable along the length of the washing material to function as a wringer, among other things. The handheld washing apparatus may be bunched or wrapped to function as a traditional loofah or scrubber, or may be unwound and extended to aid in cleaning hard-to-reach areas. The wringer effectively cleans and speeds the drying of the washing material, in addition to the washing material air drying faster when extended.

### CROSS-REFERENCE TO RELATED APPLICATIONS

This application claims the benefit of U.S. Provisional Application Ser. No. 63/625,673, filed on Jan. 26, 2024, which is incorporated herein by reference.

### TECHNICAL FIELD

The present disclosure relates to bathing, hygiene, and other types of washing. More specifically, the present disclosure relates to a handheld device that aids in scrubbing, cleaning, and exfoliating a person's skin, particularly in hard-to-reach places, as well as scrubbing and cleaning other objects or surfaces.

### BACKGROUND

Several products in the market help people more effectively bathe and shower. For example, individuals commonly use wash cloths, sponges, brushes, loofahs, and other implements to scrub their body. While these implements work well, they have several drawbacks and limitations. For example, many of them are not capable of being wrung out, thereby requiring long times to dry out. This can cause bacterial growth and other issues, if not properly rinsed and dried. Further, while traveling, because of the time required to wring out and dry cloths, sponges, and loofahs, many individuals are stuck packing them when they are still wet.

Additionally, many prior art bathing implements do not adequately allow a person to scrub hard-to-reach places, such as the back. To solve this problem, long-handle brushes and straps have been introduced. However, while these may work well at home, they are often difficult to use while traveling due to their size (e.g., long-handled brushes) or due to their inability to be wrung out.

In addition to bathing, there is a need for a scrubbing device that may be used for household cleaning, car washing, custodial usage, or other cleaning scenarios that is capable of easy transportation and storage and of being wrung out efficiently after use.

Accordingly, there is a need for a device that aids a user in scrubbing a body or other surfaces, assists in reaching hard-to-reach places, may be easily wrung out, and is compact for travel. The present disclosure solves these and other problems.

### SUMMARY OF EXAMPLE EMBODIMENTS

In some embodiments, a handheld washing apparatus comprises a first handle, a second handle, a washing material coupling the first handle to the second handle, and a wringer slidable on the washing material.

In some embodiments, a handheld washing apparatus comprises a body comprising a first member configured to couple to a second member, and a handle, the handle configured to couple to the first member. A washing material is coupled to the first member, passes through the second member, and is coupled to the handle. The second member is slidable on the washing material to function as a wringer.

In some embodiments, the handheld washing apparatus further comprises a holder to store the handheld washing apparatus when not in use. The holder may comprise a first arm, a second arm, and a suction cup or other attachment mechanism.

In one method of use, the washing material may be wound around the body with the handle configured to couple to the first member to secure the washing material to the body to form a handheld scrubber. A user may use the handheld washing apparatus similar to a loofah. To reach a back or other hard-to-reach area, a user may hold the body in one hand, decouple the handle and hold it in the other hand, and extend the washing material around the back or other hard-to-reach area. When finished, a user may decouple the second member from the first member and may slide the second member along the length of the washing material, thereby wringing out the washing material. The apparatus may also remain in this extended position for quicker drying.

In some embodiments, a handheld washing apparatus comprises a first member, a second member, and a washing material, wherein the washing material passes through a channel of the first member and is coupled on a first end to the second member, with a second end of the washing material likewise coupled to the second member, the first member being slidable along the washing material. In some embodiments, the channel of second member comprises one or more protrusions configured to aid in wringing out the washing material. In some embodiments, the first member is pliable so that a user may apply additional pressure to the washing material as part of the wring out process.

### BRIEF DESCRIPTION OF THE DRAWINGS

FIG. 1 illustrates a handheld washing apparatus;

FIG. 2 illustrates a handheld washing apparatus with the wringer along a washing material;

FIG. 3 illustrates a handheld washing apparatus in an extended position with a second member along a washing material;

FIG. 4 illustrates a top perspective view of a body of a handheld washing apparatus;

FIG. 5 illustrates a bottom perspective view of a handheld washing apparatus;

FIG. 6 illustrates a bottom perspective view of a handheld washing apparatus with the handle removed;

FIG. 7 illustrates a disassembled view of a body of a handheld washing apparatus;

FIG. 8 illustrates a disassembled view of a body of a handheld washing apparatus;

FIG. 9 illustrates a top perspective view of a second member of a body of a handheld washing apparatus;

FIG. 10 illustrates a handheld washing apparatus with the washing material partially wrapped around the body and the handle extended;

FIG. 11 illustrates a handheld washing apparatus with the washing material wrapped around the body and the handle decoupled;

FIG. 12 illustrates a handheld washing apparatus with the washing material wrapped around the body and the handle coupled to the first member of the body;

FIG. 13 illustrates a handheld washing apparatus resting within the arms of a holder;

FIG. 14 illustrates a detailed view of a handheld washing apparatus;

FIG. 15 illustrates a detailed view of a wringer of a handheld washing apparatus;

FIG. 16 illustrates a detailed view of a wringer of a handheld washing apparatus in a wringing position;

FIG. 17 illustrates a handheld washing apparatus with a washing material extended;

FIG. 18 illustrates a detailed view of a first member of a handheld washing apparatus in a natural state;

FIG. 19 illustrates a detailed view of a first member of a handheld washing apparatus in a squeezed state;

FIG. 20 is a side elevation view of a first member of a handheld washing apparatus;

FIG. 21 illustrates a handheld washing apparatus with a washing material wrapped around a first member;

FIG. 22 illustrates a first member of a handheld washing apparatus;

FIG. 23 illustrates a detailed, cutaway view of a second member with a securing member therein of a handheld washing apparatus;

FIG. 24 illustrates a detailed view of a securing member with a washing material secured therethrough of a handheld washing apparatus;

FIG. 25 illustrates a detailed view of a securing member being inserted in a second member of a handheld washing apparatus; and

FIG. 26 illustrates a handheld washing apparatus hanging to dry by a second member.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a device that aids a user in scrubbing a body or other object, assists in reaching hard-to-reach places, may be easily wrung out, and is compact for travel. The handheld washing apparatus disclosed herein solves these problems and others.

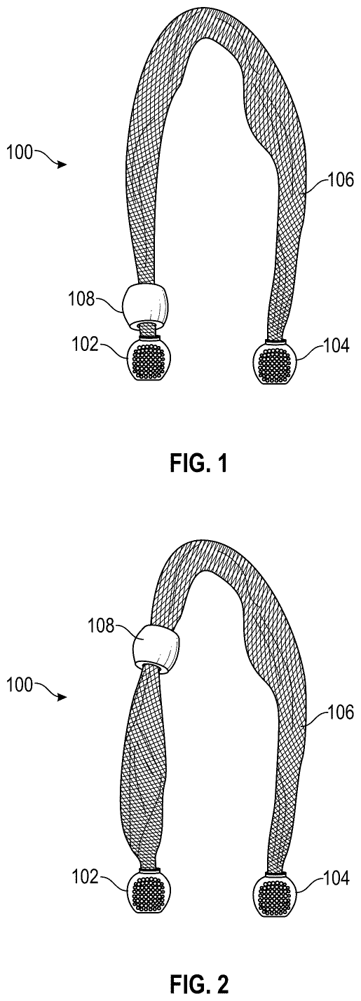

Referring to FIGS. 1-2, in some embodiments, a handheld washing apparatus 100 comprises a first handle 102, a second handle 104, a washing material 106 coupling the first handle 102 to the second handle 104, and a wringer 108 slidable on the washing material 106. The washing material may be made from known materials in the art, such as plastics, silicones, and fabrics or other textiles. In one method of use, a user may bunch up the washing material 106 to form a scrubber that may be held in one hand. In other words, a user may hold the first handle 102, second handle 104, washing material 106, and wringer 108 all in one hand. The bunched handheld washing apparatus 100 may then be used to scrub the body, surface, or object.

When a user desires to scrub a back or other hard-to-reach area, or another object, the user unravels the washing material and holds a first handle 102 with one hand, the second handle 104 with the opposite hand, and then wraps the washing material 106 around the back or other area of the body or object. When washing is complete, the user may rinse the washing material 106 and may then slide the wringer 108 along the length of the washing material 106 (i.e., from the first handle 102 to the second handle 104) to wring out the washing material 106. The user may then hang the handheld washing apparatus 100 where it may quickly dry. It will be appreciated that because the washing material 106 may be left extended, rather than bunched, it dries more rapidly than loofahs and other implements in the prior art.

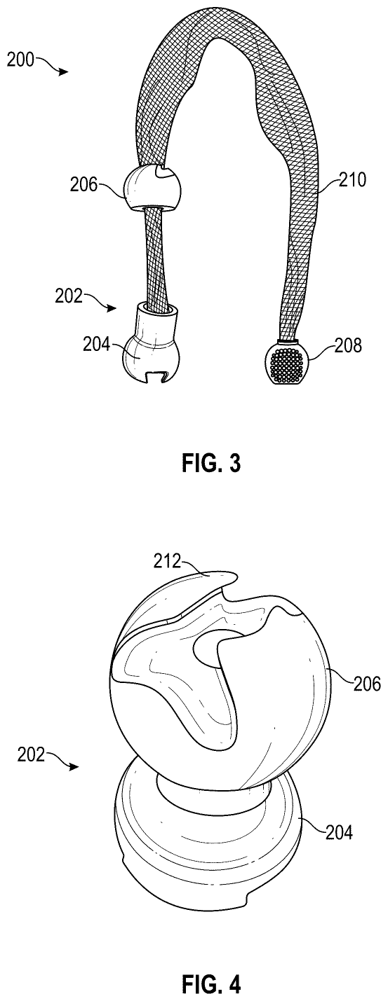

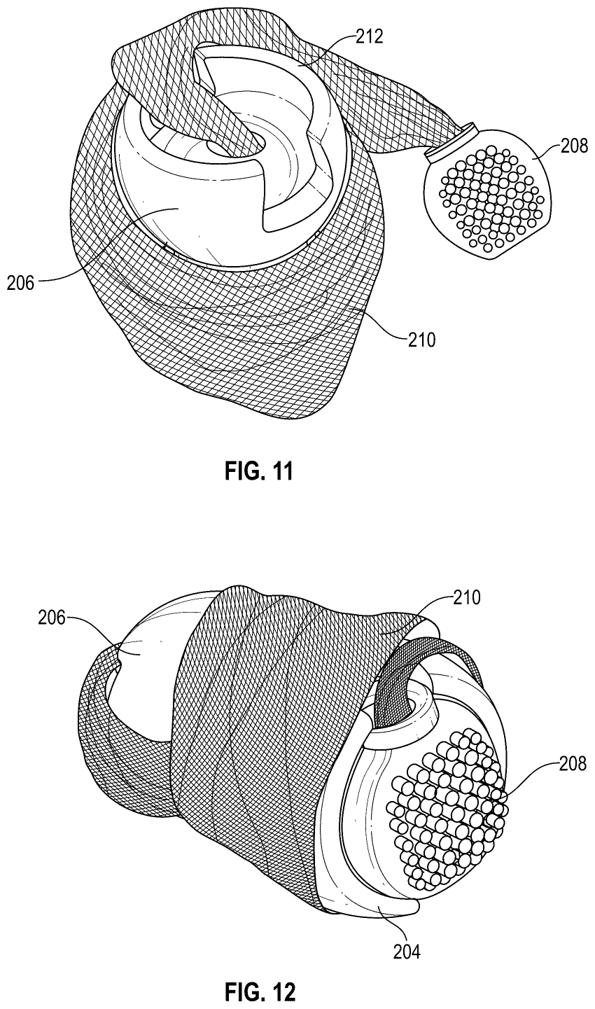

Referring to FIGS. 3-12, in some embodiments, a handheld washing apparatus 200 comprises a body 202 comprising a first member 204 configured to couple to a second member 206, and a handle 208, the handle 208 configured to couple to the first member 204. A washing material 210 is coupled to the first member 204, passes through the second member 206, and is coupled to the handle 208. The second member 206 is slidable on the washing material 210 to function as a wringer.

FIG. 4 illustrates the body 202 of the handheld washing apparatus 200, wherein the first member 204 is coupled to the second member 206. The second member 206 may comprise one or more lips 212 where the washing material 210 may be secured thereunder when wrapping the washing material 210 around the body (FIG. 10 shows an example).

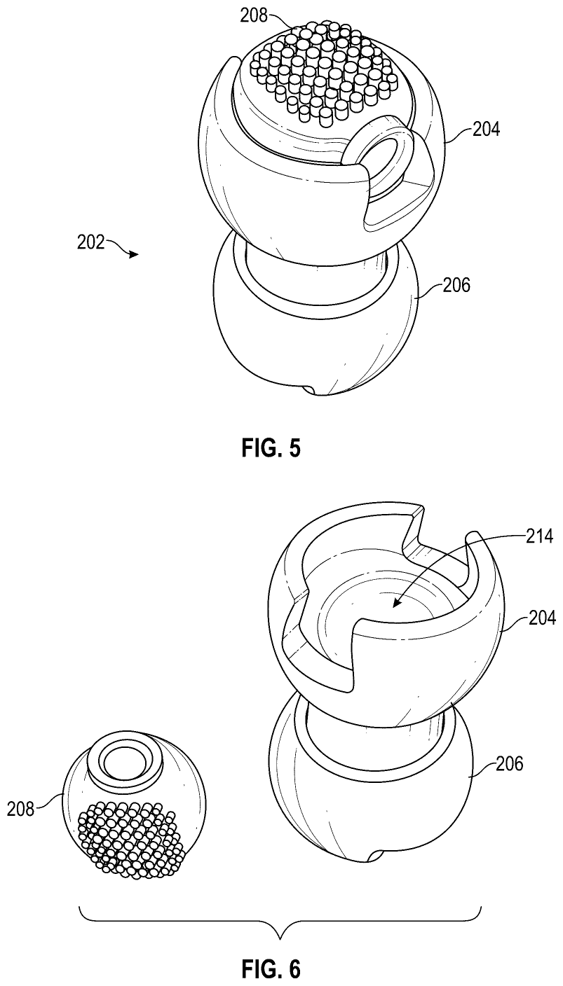

FIGS. 5-6 illustrate a bottom view of the body 202, wherein the handle 208 is removably couplable to the first member 204 by pressing the handle 208 into an aperture 214 where it is secured therein via interference fit. When assembled, this allows a user to wrap the washing material 210 around the body 202 and secure the washing material 210 to the body 202 via the lips 212 on the second member 206 and the handle 208 being secured in the aperture 214 of the first member 204 on the opposite end (FIG. 12 shows an example).

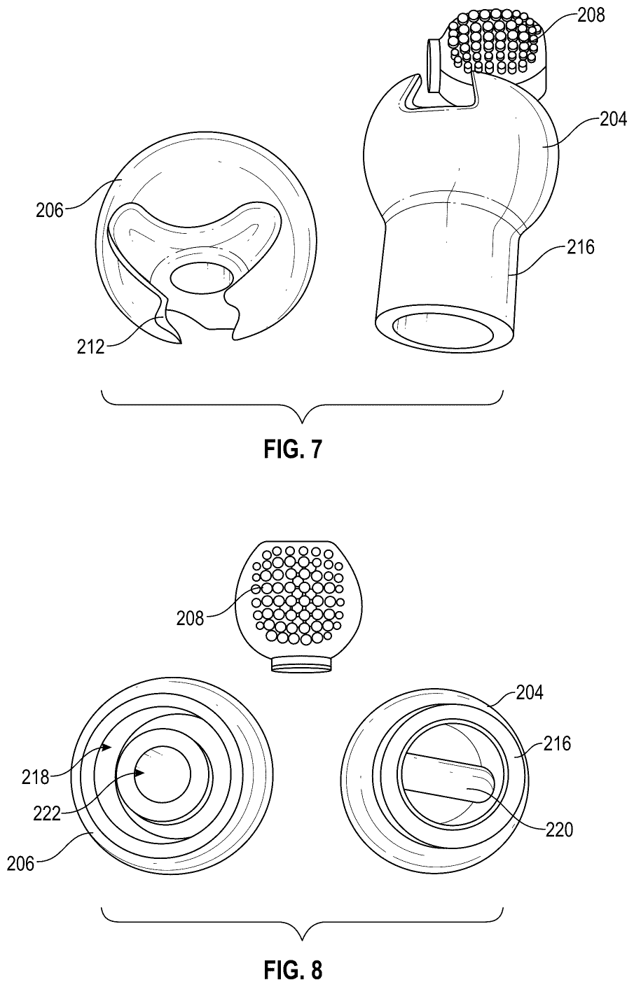

Referring to FIGS. 7-8, the first member 204 comprises a neck 216 that slides into a receiving channel 218 of the second member 206 to couple them together. They may couple together via interference fit, threading, twist and lock, or other mechanisms. A first end of the washing material 210 may be secured within the first member 204 by tying a knot around securing bar 220. However, it will be appreciated that other methods for securing the washing material 210 may be used without departing herefrom. The other end of the washing material 210 passes through material channel 222 of the second member 206 and is secured to the handle 208.

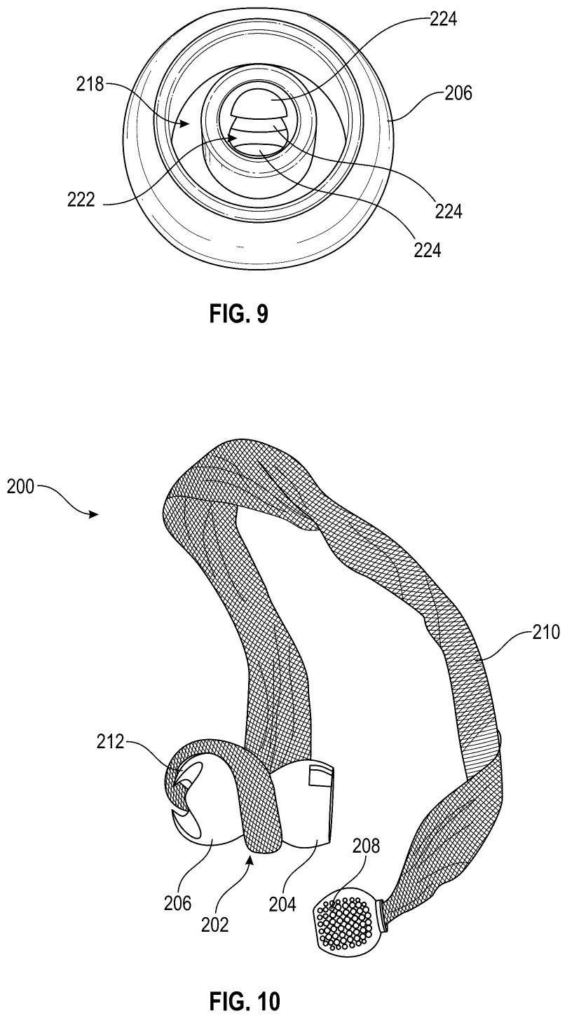

Referring to FIG. 9, the second member 206 may comprise a plurality of protrusions 224 to constrict the washing material 210 as it passes through the material channel 222. This aids in wringing out the washing material 210 so that it can be cleaned and dried much more efficiently. It will also be appreciated that the second member 206 may be manufactured from materials that allow a user to squeeze the second member 206 to thereby further constrict the washing material 210 as it passes therethrough, but that return to shape when no pressure is applied (e.g., plastics, silicones, rubbers, etc.).

In one method of use, as shown in FIGS. 10-12, the washing material 210 may be wound around the body 202 with the handle 208 configured to couple to the first member 204 to secure the washing material 210 to the body 202 to form a handheld scrubber. In this configuration, a user may use the handheld washing apparatus 200 similar to a loofah, sponge, or other scrubber. A user may extend or retract the neck 216 within the receiving channel 218 to tighten or loosen the washing material 210 around the body 202.

To reach a back or other hard-to-reach area, a user may hold the body 202 in one hand, decouple the handle 208 and hold it in the other hand, and unwrap and extend the washing material 210 around the back or other hard-to-reach area. When finished, a user may decouple the second member 206 from the first member 204 and may slide the second member 206 along the length of the washing material 210, thereby wringing out the washing material 210. Because the second member 206 wrings out the washing material 210, it effectively removes soap and residue, as well as water, keeping the washing material 210 significantly cleaner and more sanitary than traditional loofas, sponges, and wash cloths in the prior art. The handheld washing apparatus 200 may also remain in this extended position for quicker drying.

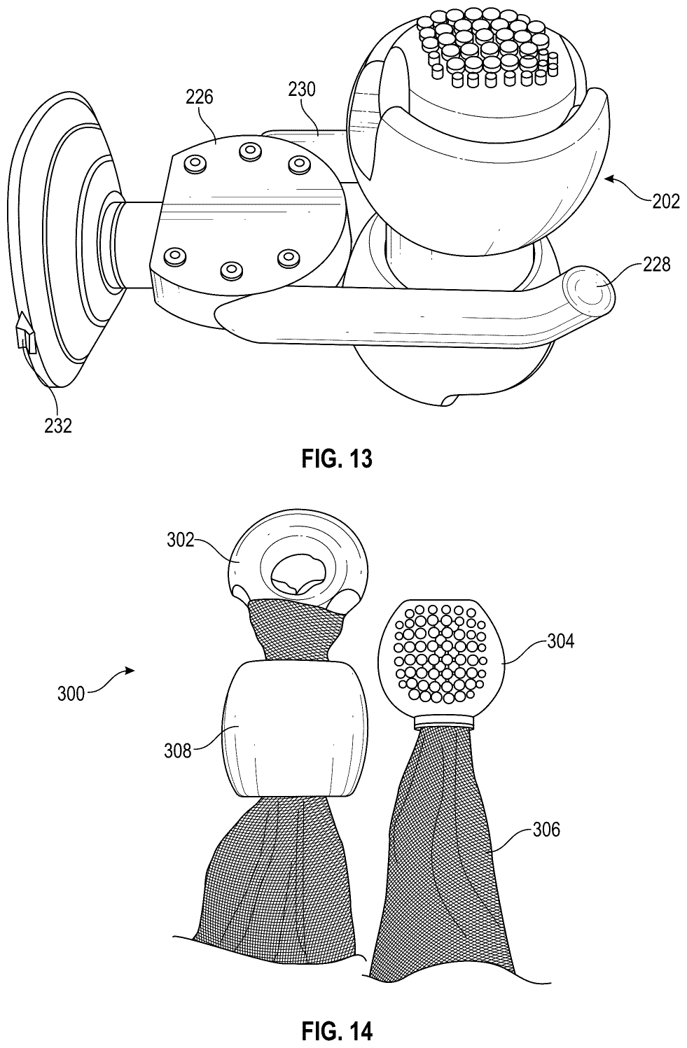

Referring to FIG. 13, in some embodiments, the handheld washing apparatus 200 further comprises a holder 226 to store the handheld washing apparatus 200 when not in use. While shown without washing material 210 in this photo, it will be appreciated that the washing material 210 may be wrapped around the body 202 or may be draped over the holder 226 to more quickly dry out. As shown, the holder 226 may comprise a first arm 228, a second arm 230, and a suction cup 232 or other attachment mechanism.

Referring to FIG. 14, in some embodiments, a handheld washing apparatus 300 comprises a first handle 302, a second handle 304, a washing material 306, and a wringer 308 slidable on the washing material 306. As shown, the first handle 302 may be configured as a ring, allowing a user to more easily grasp the first handle 302 or to utilize the first handle 302 with a finger. While the ring configuration is only shown in FIG. 14, it will be appreciated that the ring configuration may be used with other embodiments discussed herein. In one example of use, a user would bunch the washing material 306 together with the first and second handles 302 and 304, thereby creating a configuration similar to a loofah in the prior art. However, when a user desires to wash hard-to-reach areas, like the user's back, the user may grasp the first handle 302 in one hand, the second handle 304 in the second hand, extend the washing material 306 therebetween, and then clean around the user's back or other hard-to-reach area.

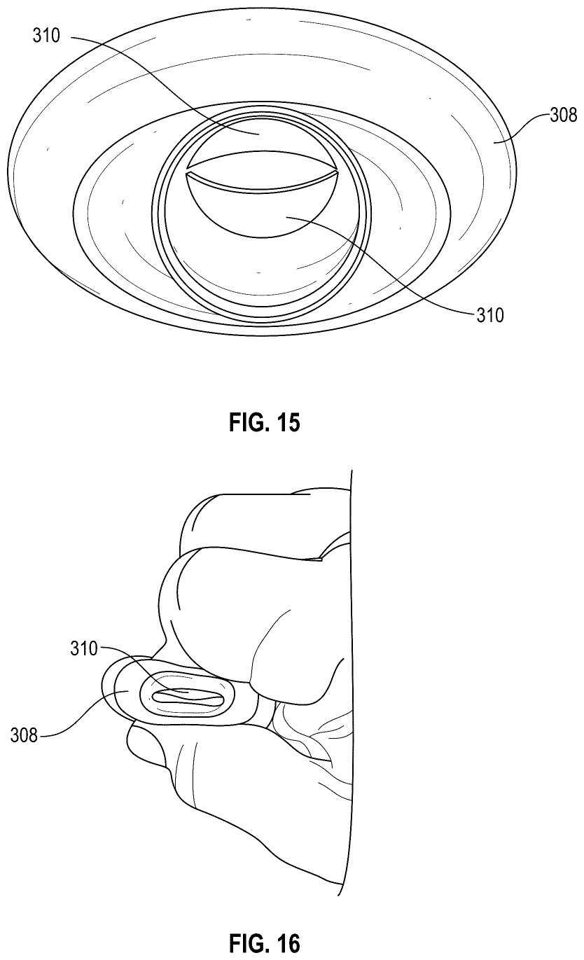

When complete, a user may easily wring out the washing material 306 using the wringer 308. As shown in FIG. 15, the wringer 308 may comprise one or more constrictors or protrusions 310 on an interior of the wringer 308, thereby applying pressure to the washing material 306. As shown in FIG. 16, the wringer 308 is made of flexible material, thereby allowing a user to squeeze opposing sides of the wringer 308, forcing the protrusions 310 towards one another, thereby applying greater force on the washing material 306. Accordingly, a user may squeeze the wringer 308 and then slide the wringer 308 along the length of the washing material, thereby wringing out the washing material efficiently. It will be appreciated that the wringer 308 may also be used or combined with other embodiments disclosed herein. Further, the wringer 308 may likewise be used as an aftermarket accessory for other washing materials, such as a washcloth. A user may insert one end of a washcloth through the wringer 308, then grasp and pull the washcloth through the wringer 308 while simultaneously squeezing the wringer 308 to thereby wring out the washcloth.

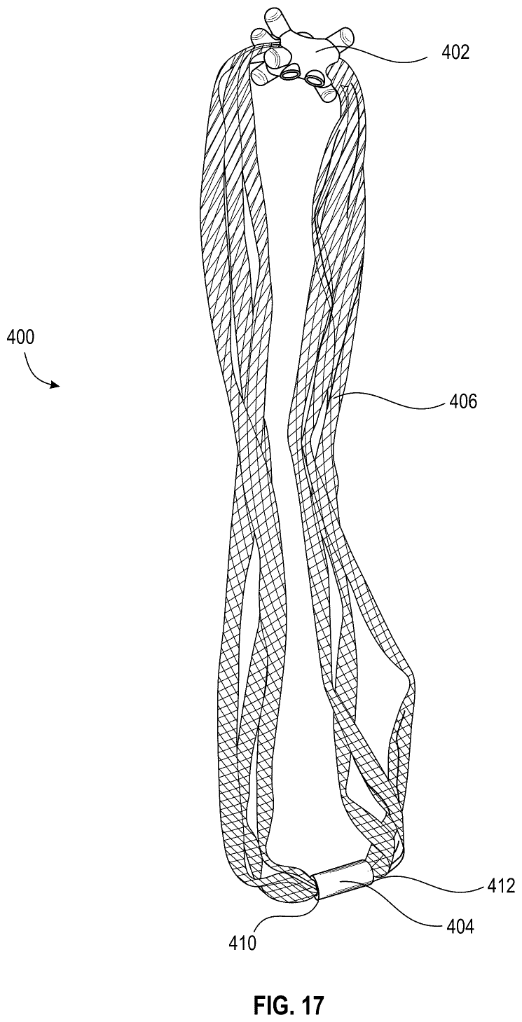

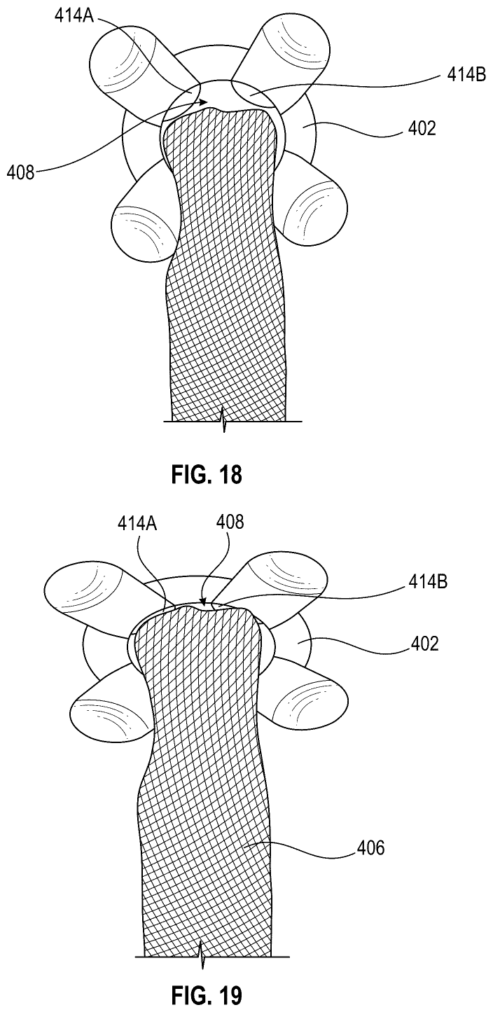

Referring to FIGS. 17-26, in some embodiments, a handheld washing apparatus 400 comprises a first member 402, a second member 404, and a washing material 406, wherein the washing material 406 passes through a channel 408 of the first member 402 and is coupled on a first end 410 to the second member 404, with a second end 412 of the washing material 406 likewise coupled to the second member 404, the first member 402 being slidable along the washing material 406. In some embodiments, as shown in FIGS. 18-19, the channel 408 of first member 402 comprises one or more protrusions 414A-B configured to aid in wringing out the washing material 406. In some embodiments, as shown in FIG. 19, the first member 402 is pliable so that a user may apply additional pressure to the washing material 406 by squeezing the first member 402 so that the channel 408 narrows and the protrusions 414A-B apply additional pressure to the washing material 406 as part of the wring out process.

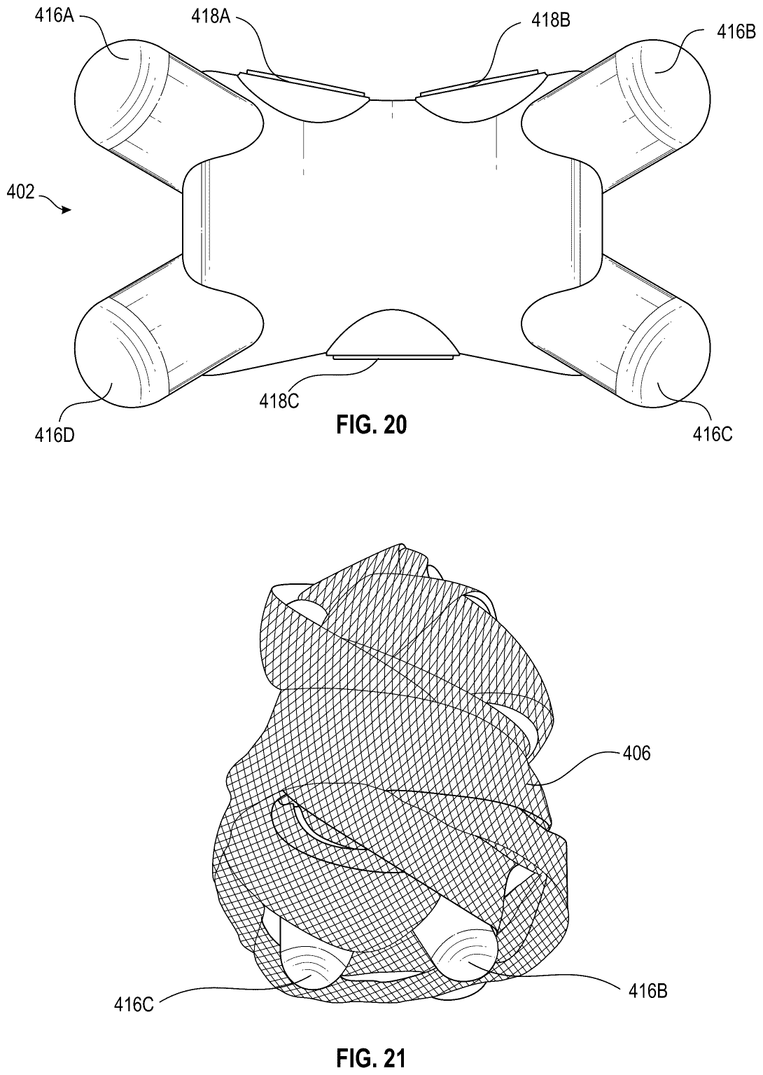

FIG. 20 is a side elevation view of the first member 402. As shown, the first member 402 may comprise a plurality of arms 416A-D (additional arms not visible in this view) and one or more gripping surfaces 418A-C. As shown in FIG. 21, the arms 416A-D may aid in wrapping the washing material 406 around the first member 402, and may additionally provide for additional scrubbing surfaces. The gripping surfaces 418A-C may aid a user in both maintaining a grip on the first member 402 as well as indicating pressure points for squeezing during wringing. Because the gripping surfaces 418A-C are offset from one another, the washing material 406 is constricted as it passes through the channel 408 rather than being stopped.

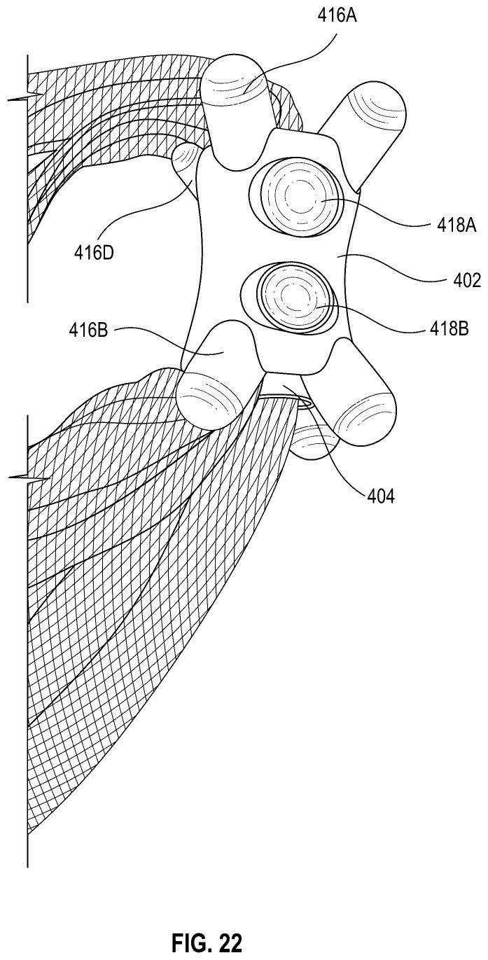

Referring to FIG. 22, in some embodiments, the second member 404 is receivable within the channel 408 of the first member 402. This may be helpful to shorten the length of the washing material 406 during use, during storage, or to make it easier to wrap around the first member 402. The second member 404 remains wedged between the one or more protrusions 414A-B to be secured via interference fit. A user may simply pull the second member 404 from within the channel 408 of the first member 402 when desired.

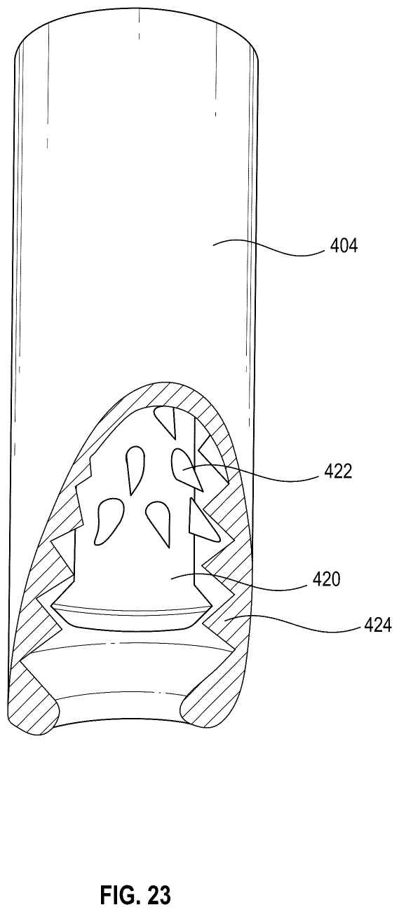

Referring to FIG. 23, the washing material 406 may be secured to the second member 404 via a securing member 420 comprising a plurality of spikes 422 being inserted into the second member 404. The second member 404 may comprise a plurality of spikes 424 in an opposite direction of the spikes 422, to thereby prevent unintended withdrawal, the spikes 422, 424 interlocking with one another. It will be appreciated that the washing material 406 may be wrapped around the securing member 420 before being inserted, thereby interposing the washing material 406 between the spikes 422 and 424.

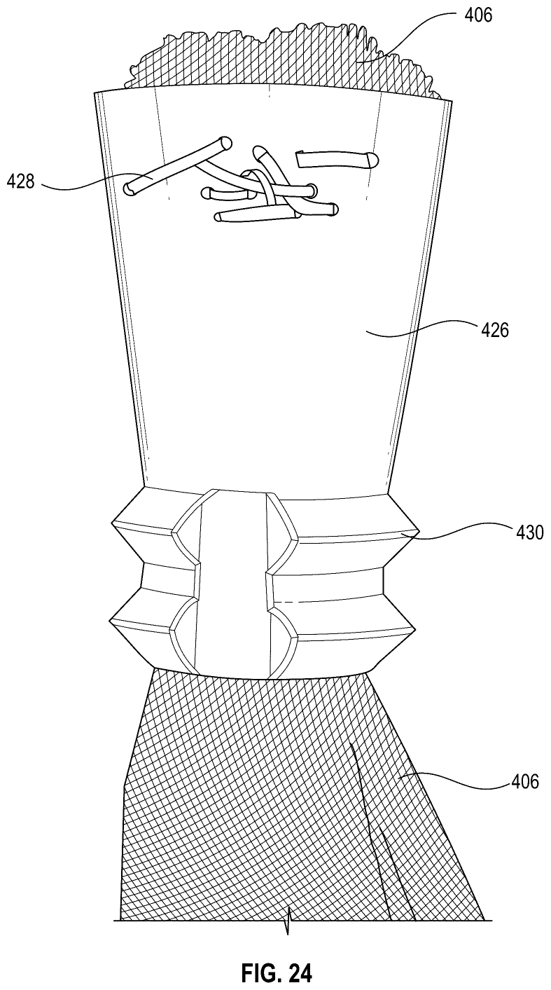

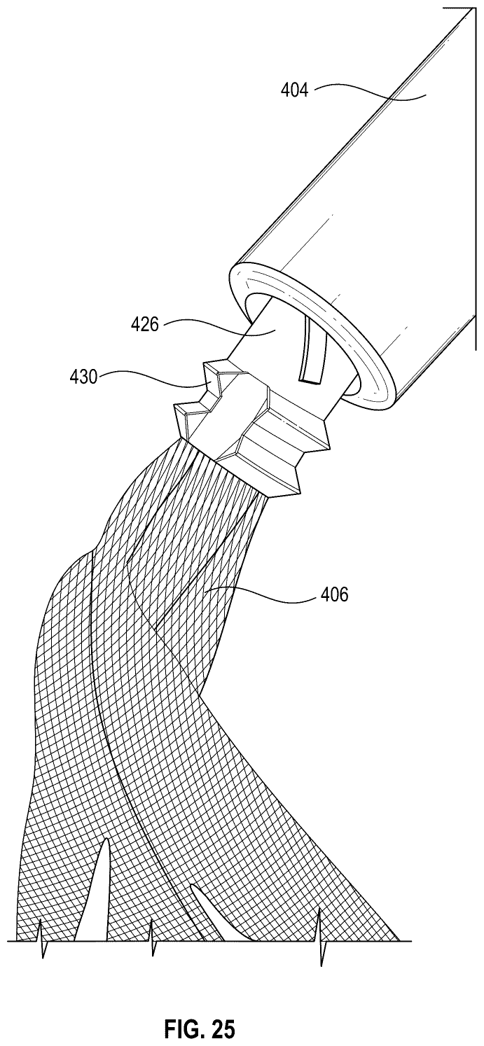

Referring to FIG. 24-25, another method of securing the washing material 406 to the second member 404 is illustrated. In this example, the washing material 406 passes through a securing member 426 and is secured therein using plastic tags 428 or an equivalent securing mechanism. As shown in FIG. 25, the securing member 426 is then inserted into the second member 404 until one or more securing protrusions 430 are received therein. The outer diameter of the securing protrusions 430 may be larger than an inner diameter of the second member 404, allowing the securing member 426 to remain lodged therein via interference fit. However, it will be appreciated that while interference fit is used as an example, other mechanisms may be used, such as twist and lock, threads, and other mechanisms. For example, if twist and lock or threads are used, it will be appreciated that securing member 426 and second member 404 will have complementary configurations (e.g., tongue and groove, threads, channel and protrusion, etc.) to ensure that unintended withdrawal is prevented once they are mated.

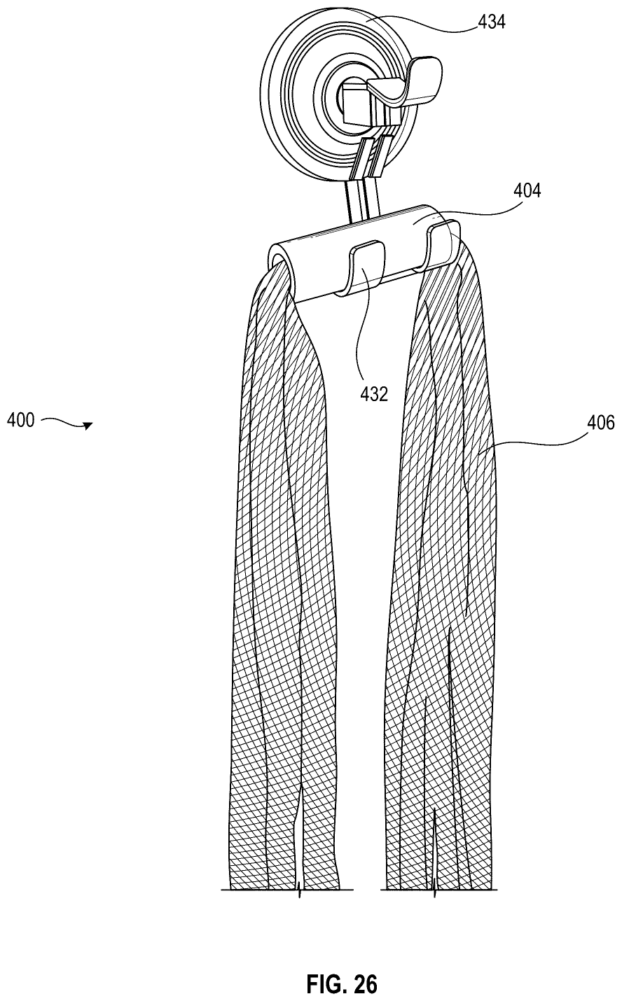

Referring to FIG. 26, the handheld washing apparatus 400 may be hung to more easily dry out as well. For example, the second member 404 may be received in a hook 432, allowing the washing material 406 to air dry. The hook 432 may be secured to a wall using a suction cup 434 or other mechanism.

Accordingly, the handheld washing apparatus 100, 200, 300, and 400 disclosed herein solves the need for a device that aids a user in scrubbing a body or other object or surface, assists in reaching hard-to-reach places (particularly for those with limited mobility or who are in obese in size), may be easily wrung out and dried, and is compact for travel.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A handheld washing apparatus, comprising:
a first member;
a second member; and
a washing material;
wherein the washing material passes through a channel of the first member and is secured at a first end and a second end to the second member.

2. The handheld washing apparatus of claim 1, wherein the channel of the first member comprises one or more protrusions therein.

3. The handheld washing apparatus of claim 1, wherein the first member is pliable.

4. The handheld washing apparatus of claim 3, wherein the first member comprises one or more gripping surfaces.

5. The handheld washing apparatus of claim 1, wherein the first member comprises at least one arm extending outwardly therefrom.

6. The handheld washing apparatus of claim 1, wherein the second member is configured to be received within the channel of the first member and remain secured via interference fit.

7. The handheld washing apparatus of claim 1, wherein the washing material is secured to the second member via the washing material extending around a securing member comprising a plurality of first spikes extending in a first direction, the securing member forced within the second member, the second member comprising a plurality of second spikes extending in a second direction, the first and second spikes configured to interlock with one another.

8. The handheld washing apparatus of claim 1, wherein the washing material is secured to the second member via insertion into a securing member comprising one or more securing protrusions, with one or more plastic tags passing through the securing member and the washing material to secure them together, the securing member configured to insert into the second member until the securing protrusions are received therein, securing the securing member to the second member via interference fit.

9. A handheld washing apparatus, comprising:
a first member, comprising:
a channel,
a plurality of protrusions positioned inside the channel,
one or more gripping surfaces, and
one or more arms extending outwardly therefrom;
a second member, comprising:
a securing member received within the second member; and
a washing material;
wherein the washing material passes through the channel of the first member and is secured at a first end and a second end to the second member.

10. The handheld washing apparatus of claim 9, wherein the first member is pliable.

11. The handheld washing apparatus of claim 9, wherein the second member is configured to be received within the channel of the first member and remain secured via interference fit.

12. The handheld washing apparatus of claim 9, wherein the washing material is secured to the second member via the washing material extending around the securing member, the securing member comprising a plurality of first spikes extending in a first direction, the securing member forced within the second member, the second member comprising a plurality of second spikes extending in a second direction, the first and second spikes configured to interlock with one another.

13. The handheld washing apparatus of claim 9, wherein the washing material is secured to the second member via insertion into the securing member comprising one or more securing protrusions, with one or more plastic tags passing through the securing member and the washing material to secure them together, the securing member configured to insert into the second member until the securing protrusions are received therein, securing the securing member to the second member via interference fit.

14. A method of using a handheld washing apparatus, the method comprising:
holding a first member in a first hand;
holding a second member in a second hand, a washing material extending between the first and second members; and
washing an area of a body or object using the washing material.

15. The method of claim 14, further comprising inserting the second member into a channel of the first member, and wrapping the washing material around the first member to form a scrubber.

16. The method of claim 14, further comprising wringing out the washing material by squeezing the first member while pulling the washing material through a channel of the first member.

17. The method of claim 14, further comprising hanging the second member in a hook to allow the washing material to air dry.

18. The method of claim 17, wherein after the washing material has dried, inserting the second member into a channel of the first member, and wrapping the washing material around the first member for storage and transportation.

19. The method of claim 18, wherein the washing material remains secured around the first member via one or more arms.
